(19) United States
(12) Patent Application Publication
(10) Pub. No.: US 2007/0022321 A1
(43) Pub. Date: Jan. 25, 2007

(54) Exception analysis methods and systems

(75) Inventors: Huey-Tyug Chua, Chu-Tung Town (TW); Yann-Chang Lin, Hsin-Chu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/176,766

(22) Filed: Jul. 7, 2005

(51) Int. Cl. G06F 11/00

(52) U.S. Cl. 714/38

(57) ABSTRACT

Exception analysis methods for embedded systems. System exceptions from an embedded system with an operating system are received. Each system exception comprises first error code portion and second error code portion. The system exceptions are classified into error categories according to the first error code portion. The categories are based on components of the operating system of the embedded system. Each error category includes error types. The system exceptions are then analyzed to determine the error types of the system exceptions according to the classified error categories and the second error code portion.

### BACKGROUND

The invention relates to exception analysis, and in particular to exception analysis for embedded systems.

Embedded systems are generally designed for specific application devices, such as mobile phones or personal digital assistants (PDAs). An embedded system generally comprises a combination of hardware and software, either fixed or programmable. Therefore, the specific system components of an embedded system cause different system operations thereamong. Thus, system exceptions, that is, errors produced by software, hardware, or both, occur widely and can be difficult to handle in embedded systems, especially in multi-tasking or multi-threading embedded systems.

Conventionally, system exceptions of embedded systems are analyzed and handled manually. For example, when a system exception is found, the system exception is analyzed by engineers to determine a specific cause for further handling. The analysis result is then transferred to responsible parties for handling according to the determined cause.

Conventional methods are time-consuming and unsystematic. With widespread applications of embedded systems, system exception response is time-limited and important for application in embedded systems. Thus, conventional methods for system exception analysis cannot satisfy current or future requirements.

Automatic system exception analysis methods and systems to accelerate system exception response are desirable.

### SUMMARY

An exemplary embodiment of an exception analysis method for embedded systems receives system exceptions from an embedded system. Each system exception comprises first and second error code portions. The system exceptions are classified into error categories according to the first error code portion. The embedded system includes an operating system and the error categories are based on the components thereof. Each error category includes various error types. System exceptions are then analyzed to determine the error types according to the classified error categories and the second error code portion.

### DESCRIPTION OF THE DRAWINGS

The invention can be more fully understood by reading the subsequent detailed description and examples with references made to the accompanying drawings, wherein:

FIG. 1 is a flowchart of an embodiment of an exception analysis method for embedded systems.

FIG. 2 is a diagram of an embodiment of an exception analysis system for embedded systems.

FIG. 3 is a flowchart of an exemplary embodiment of an exception analysis method implemented in an embedded system.

FIG. 4 is a diagram of an exemplary embodiment of an exception analysis system implemented in an embedded system.

FIG. 5A-5B are diagrams of an exemplary embodiment of error categories and error type.

FIG. 6 is a diagram of an exemplary embodiment of mapping tables.

### DESCRIPTION

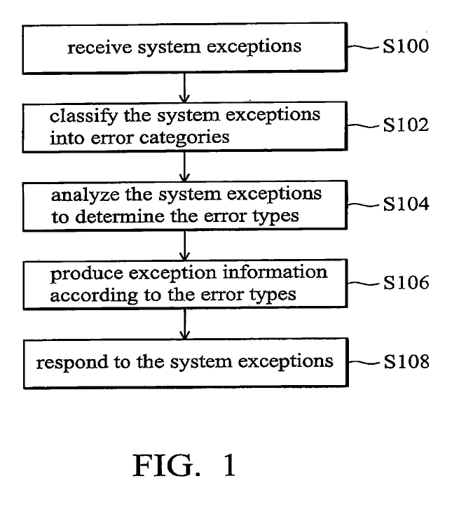

Exception analysis methods for embedded systems are provided. FIG. 1 is a flowchart of an embodiment of an exception analysis method for embedded systems. System exceptions are received from an embedded system (Step S100). Each system exception includes first error code portion and second error code portion.

The system exceptions are then classified into error categories according to the first error code portion (step S102). The embedded system has an operating system and the error categories are based on components of the operating system. For example, if the operating system of the embedded system includes 7 main components, the error categories are classified into 7 error categories. Each error category comprises various error types. The system exceptions are analyzed to determine the error types according to the classified error categories and the second error code portion (Step S104). Additionally, a mapping table, recording the relationships between the first error code portion and error categories, is provided in the embedded system for exception classification.

Thereafter, exception information of the system exceptions according to the analyzed error types is produced (Step S106). The exception information may comprise detailed exception messages, analysis results, and guidelines. The system exceptions can be responded according to the exception information (Step S108). The exception information can be transmitted by a transmission channel, such as a cable, to output media or stored in a storage device, such as a flash memory device, for further response.

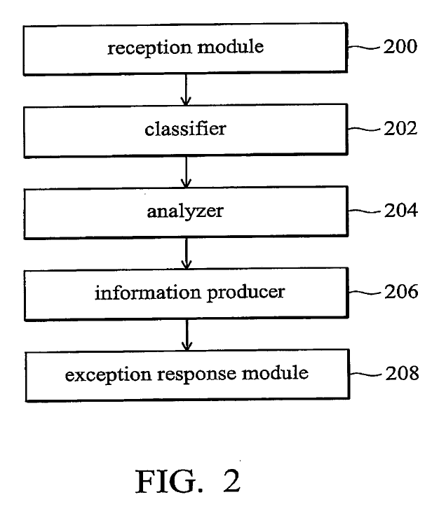

Exception analysis systems for embedded systems are further provided. FIG. 2 is a diagram of an embodiment of an exception analysis system for embedded systems. The exception analysis system comprises a reception module 200, a classifier 202, an analyzer 204, an information producer 206, and an exception response module 208. A mapping table may be provided in the embedded system for classification. The mapping table records the relationships between the first error code portion and error categories.

The reception module 200 receives system exceptions from an embedded system having an operating system. Each system exception comprises first and second error code portion. The classifier 202 classifies the system exceptions into error categories according to the first error code portion. The error categories are based on components of the operating system and each error category comprises various error types. The analyzer 204 analyzes the system exceptions to determine the error types of the system exceptions according to the classified error categories and the second error code portion.

The information producer 206 produces exception information of the system exceptions according to the analyzed error types. The exception response module 208 responds to system exceptions according to the exception information. Here, again, the exception information may comprise detailed exception messages, analysis results, and guidelines. The exception information can be transmitted by a transmission channel or stored in a storage device. The exception analysis system can be implemented in a chip built in the embedded system.

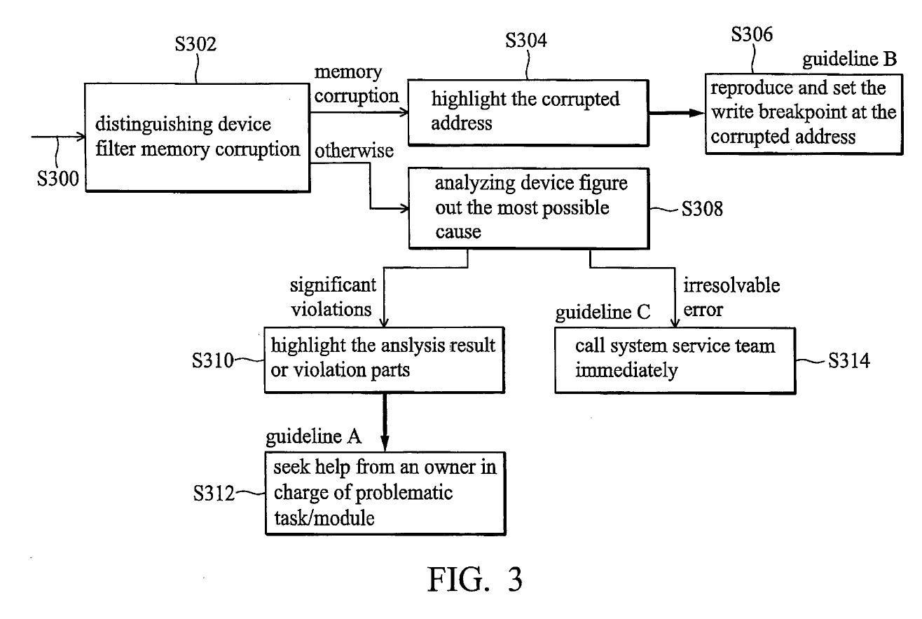

FIG. 3 is a flowchart of an exemplary embodiment of an exception analysis method implemented in an embedded system. The exception analysis method is the detailed implementation of the Step S104, and is implemented by the analyzer 204. Here, because exceptions caused by memory corruption are more complicated than others, system exceptions thereby can be distinguished to be particular error types.

As shown in FIG. 3, a system exception classified into be a specific error category is received (Step S300), and the error types of memory corruption are distinguished from other error types (Step 302, implemented by a distinguishing device), and the corrupted address is then highlighted (Step S304). A guideline, i.e. guideline B, is then produced in response to the system exception (step S306). Here, guideline B (i.e. the exception information) is to reproduce and set the write breakpoint at the corrupted address.

In step S302, if the system exception is analyzed to be other error types, the most possible cause of the system exception is figured out (step S308, implemented by an analyzing device). In the embodiment, system exceptions can be analyzed as significant violations or irresolvable errors (step S308). In step S308, if the system exception is analyzed as a significant violation, the analysis result or violation part is highlighted (step S310). Thereafter, corresponding guideline A is then produced (step S312). Here, guideline A (i.e. the exception information) is to seek help from an owner in charge of problematic task/module.

In step S308, if the system exception is analyzed as an irresolvable error, guideline C (i.e. the exception information) is produced. Guideline C calls system service team immediately (step S314).

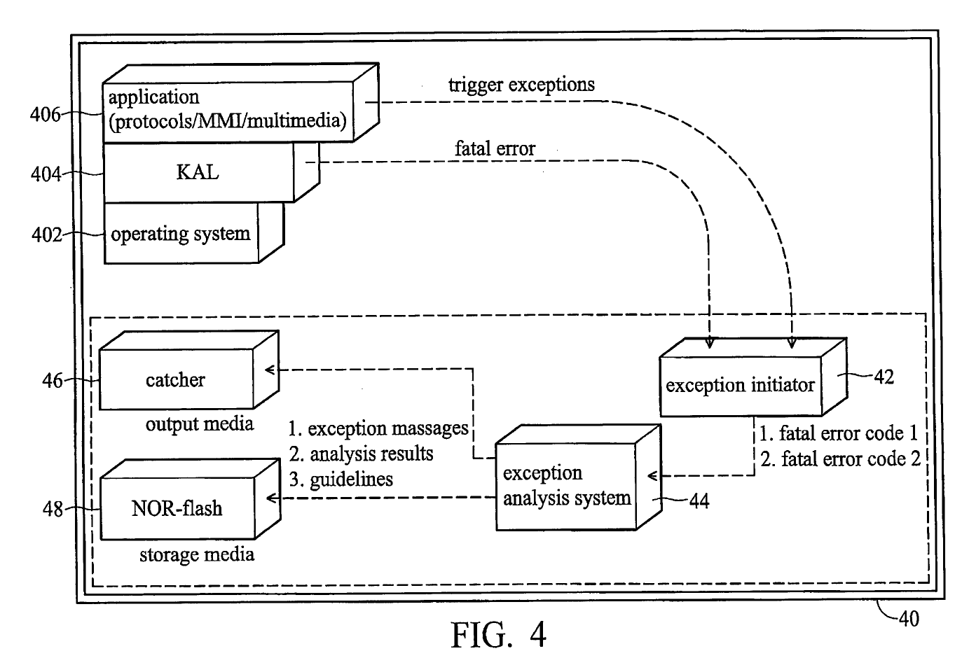

FIG. 4 is a diagram of an exemplary embodiment of an exception analysis system implemented in an embedded system. An exception analysis system 44 is included and implemented in an embedded system 40 with an operating system 402. The embedded system may further comprise a kernel adaptation layer 404 and application layer 406. When a system exception is trigged/generated, for example, by a central control unit (CPU) of the embedded system or a fatal error, the kernel adaptation layer 404 initiates an exception initiator 42. The exception initiator 42 is an entry of the exception analysis system. The system exception includes first and second error code portion when it is sent to the exception analysis system 44, a main part for error analysis.

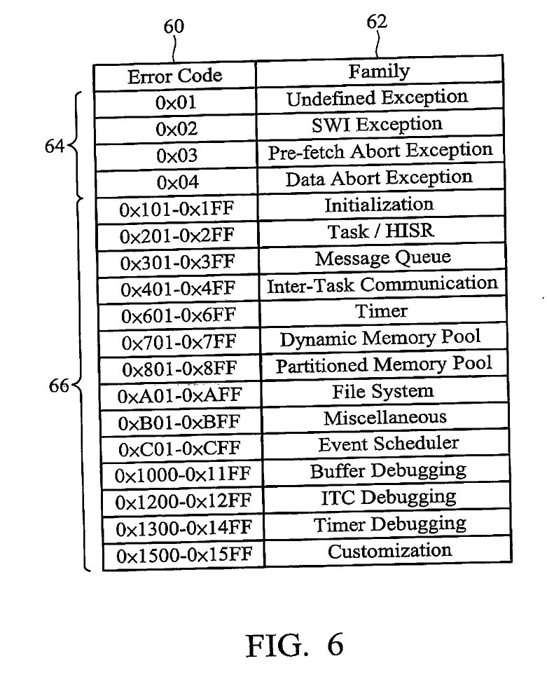

Additionally, a mapping tables is provided in the embedded system 40. FIG. 6 is a diagram of an exemplary embodiment of the mapping table. The mapping tables records the relationships between the first error code portion and error categories. In the embodiment, the first error code portion is represented in the first column 60 (Error Code). Error categories are expressed in the second column 62 (Family). Error codes 64, which are 0x01, 0x02, 0x03, and 0x04, represent exceptions triggered by the CPU. Error codes 66 from 0x101 to 0x15FF is divided into different error categories. Each error category includes various error types. The first four error types of each error category are also memory corruption.

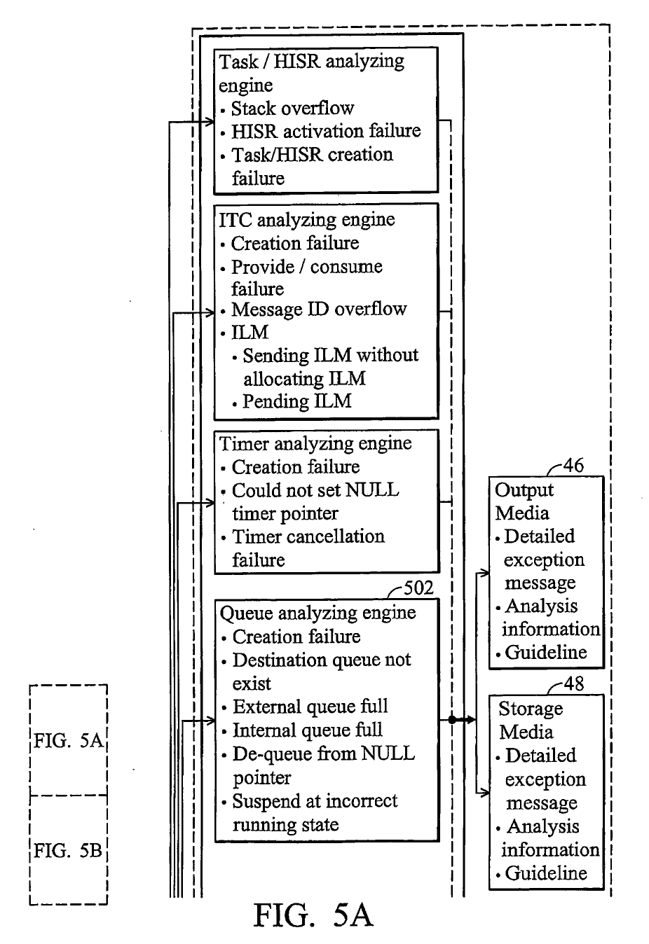

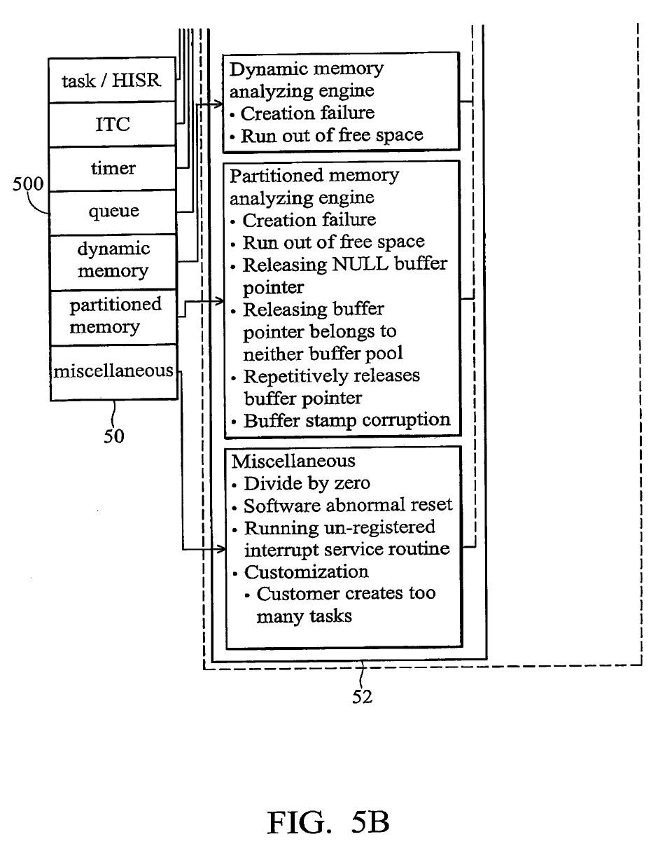

Referring to FIG. 4 again, the exception analysis system 44 receives the system exception and classifies the system exception to an error category according to the first error code portion, as 50 in FIGS. 5A and 5B. The error categories 50 are based on components of the operating system 402. In the embodiment, the operating system 402 includes 7 components, i.e. task/HISR, ITC, timer, queue, dynamic memory, partitioned memory, and miscellaneous, thus the error categories are classified accordingly. Each error category comprises various error types, as 52 in FIGS. 5A and 5B.

The exception analysis system 44 analyzes the system exception to determine the error type of the system exception according to the classified error category and the second error code portion. For example, if the received system exception is classified as queue error category 500, the exception analysis system 44 then determines the error type of the system exception, for example, creation failure, according to the classified error category and the second error code portion.

The exception analysis system 44 produces exception information of the system exception according to the analyzed error type. The exception analysis system 44 responds the system exception according to the exception information. The exception information may comprise detailed exception messages, analysis results, and guidelines. The exception information may be transmitted by a transmission channel to an output media 46. The exception information may also be stored to a storage device 48. The exception analysis system 44 can be implemented in a chip built in the embedded system 40.

Referring back to FIG. 4, if the exception information is transmitted by a transmission channel to an output media 46, such as a computer, the computer may be installed a hyper-terminal to respond to the exceptions according to the exception information. If the exception information is stored in a storage media 48, such as a flash memory device, the storage media may allocate memory space for information storage.

As described, the provided methods and systems can analyze system exceptions at runtime automatically to produce exception information and further to respond to the exceptions, accelerating solution time efficiently. The provided methods and systems represent outstanding execution results significantly when employed in an embedded system.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents

What is claimed is:

1. An exception analysis method for embedded systems, comprising:
receiving system exceptions from an embedded system with an operating system, wherein each system exception comprises first error code portion and second error code portion;
classifying the system exceptions into at least one error category according to the first error code portion, wherein the error categories are based on components of the operating system and each error category comprises at least one error type; and
analyzing the system exceptions to determine the error types of the system exceptions according to the classified error categories and the second error code portion.

2. The exception analysis method for embedded systems as claimed in claim 1, further providing a mapping table in the embedded system, wherein the mapping table records the relationships between the first error code portion and the error category.

3. The exception analysis method for embedded systems as claimed in claim 1, wherein the step of analyzing further comprises:
distinguishing error types of memory corruptions from other error types; and
analyzing the other error types to be error types of significant violations or error types of irresolvable errors.

4. The exception analysis method for embedded systems as claimed in claim 1, further producing exception information of the system exceptions according to the analyzed error types.

5. The exception analysis method for embedded systems as claimed in claim 4, further responding to the system exceptions according to the exception information.

6. The exception analysis method for embedded systems as claimed in claim 4, wherein the exception information comprises detailed exception messages, analysis results, and guidelines.

7. The exception analysis method for embedded systems as claimed in claim 4, wherein the exception information is transmitted to a media by a transmission channel.

8. The exception analysis method for embedded systems as claimed in claim 4, wherein the exception information is stored in a storage device.

9. An exception analysis system for embedded systems, comprising:
a reception module, receiving system exceptions from an embedded system with an operating system, wherein each system exception comprises first error code portion and second error code portion;
a classifier, coupled to the reception module, classifying the system exceptions into at least one error category according to the first error code portion, wherein the error categories are based on components of the operating system and each error category comprises at least one error type; and
an analyzer, coupled to the classifier, analyzing the system exceptions to determine the error types of the system exceptions according to the classified error categories and the second error code portion.

10. The exception analysis system for embedded systems as claimed in claim 9, further comprising a mapping table provided in the embedded system, wherein the mapping table records the relationships between the first error code portion and the error category.

11. The exception analysis system for embedded systems as claimed in claim 9, the analyzer further comprises:
a distinguishing device for distinguishing error types of memory corruptions from other error types; and
an analyzing device for analyzing the other error types to be error types of significant violations or error types of irresolvable errors.

12. The exception analysis system for embedded systems as claimed in claim 9, further comprising an information producer, coupled to the analyzer, producing exception information of the system exceptions according to the analyzed error types.

13. The exception analysis system for embedded systems as claimed in claim 12, further comprising an exception response module, coupled to the information producer, responding to the system exceptions according to the exception information.

14. The exception analysis system for embedded systems as claimed in claim 12, wherein the exception information comprises detailed exception messages, analysis results, and guidelines.

15. The exception analysis system for embedded systems as claimed in claim 12, wherein the exception information is transmitted to a media by a transmission channel.

16. The exception analysis system for embedded systems as claimed in claim 12, wherein the exception information is stored in a storage device.

17. The exception analysis system for embedded systems as claimed in claim 9, wherein the exception analysis system is implemented in a chip built into the embedded system.

18. An exception analysis method for embedded systems, comprising:
receiving system exceptions from an embedded system, wherein each system exception comprises first error code portion and second error code portion;
classifying the system exceptions into at least one error category according to the first error code portion, wherein each error category comprises at least one error type; and
analyzing the system exceptions to determine the error types of the system exceptions according to the classified error categories and the second error code portion.

19. The exception analysis method for embedded systems as claimed in claim 18, wherein the embedded system comprises an operating system, and the error categories are based on components of the operating system.

20. An exception analysis system for embedded systems, comprising:
a reception module, receiving system exceptions from an embedded system, wherein each system exception comprises first error code portion and second error code portion;
a classifier, coupled to the reception module, classifying the system exceptions into at least one error category according to the first error code portion, wherein each error category comprises at least one error type; and
an analyzer, coupled to the classifier, analyzing the system exceptions to determine the error types of the system exceptions according to the classified error categories and the second error code portion.

21. The exception analysis system for embedded systems as claimed in claim 20, wherein the embedded system comprises an operating system, and the error categories are based on components of the operating system.
